(19) United States
(12) Patent Application Publication
(10) Pub. No.: US 2026/0342445 A1
(43) Pub. Date: Oct. 29, 2026

(54) CODE-BASED SECTOR SELECTION FOR WIRELESS COMMUNICATION

(71) Applicant: SIGNIFY HOLDING B.V., EINDHOVEN (NL)

(72) Inventors: PAUL HENRICUS JOHANNES MARIA VAN VOORTHUISEN, SINT OEDENRODE (NL); JOHAN PAUL MARIE GERARD LINNARTZ, EINDHOVEN (NL)

(21) Appl. No.: 19/123,496

(22) PCT Filed: Oct. 24, 2023
(86) PCT No.: PCT/EP2023/079560

§ 371 Date: Apr. 23, 2025

(30) Foreign Application Priority Data
Oct. 31, 2022 (EP) 22204644.3

(51) Int. Cl. H04B 10/516; H04B 10/11; H04B 10/40

(52) U.S. Cl. CPC H04B 10/5161; H04B 10/11; H04B 10/40

(57) ABSTRACT

The invention relates to a wireless communication system with a transmitter that is capable of sending data into one or more different, possibly partially overlapping sectors. To identify which sector(s) is (are) most suitable for communication, a suitable choice of codes is suggested and a set of different code patterns to be used for identifying different sectors are added.

### FIELD OF THE INVENTION

The invention relates to the field of wireless communication systems in various environments, such as—but not limited to—lighting systems, for use in various different applications for home, office, retail, hospitality and industry.

### BACKGROUND OF THE INVENTION

Wireless communication via light is rapidly gaining interest. OWC systems, such as LiFi networks (named like WiFi networks), enable mobile user devices (called end points (EP) or end device (ED) units) like laptops, tablets, smartphones or the like to connect wirelessly to the internet. WiFi achieves this using radio frequencies, but LiFi achieves this using the light spectrum which can enable unprecedented data transfer speed and bandwidth. Furthermore, it can be used in areas susceptible to electromagnetic interference. An important point to consider is that wireless data is required for more than just our traditional connected devices. Today, televisions, speakers, headphones, printer's, virtual reality (VR) goggles and even refrigerators use wireless data to connect and perform essential communications. Radio frequency (RF) technology like WiFi is running out of spectrum to support this digital revolution and LiFi can help power the next generation of immersive connectivity.

OWC refers to techniques by which information is communicated in the form of a signal embedded in light (including for example visible light or invisible light, such as for example infrared (IR) light) emitted by a light source. Depending for example on the particular wavelengths used, such techniques may also be referred to as coded light, Light Fidelity (LiFi), visible light communication (VLC) or free-space optical communication (FSO). In this context, visible light may be light that has a wavelength in the range 380 nm to 740 nm and infrared (IR) light may be light that has a wavelength in the range 740 nm to 1.5 um. There may be some overlap between these ranges.

An example of such a Visible Light Communication system wherein a device is coupled to multiple transmitting communication devices, is provided in United States patent application US 2020/0195344 A1, which discloses that a device coupled to multiple transmitting communicating devices, may provide individual reference signals using a number of subcarriers or time slots in accordance to the optical clock reference and the number of transmitting communicating devices in the set to be transmitted in parallel. The device defines the position of subcarriers or of signals at the time slots in accordance to an identification number associated to an individual transmitting communicating device within the whole set of transmitting communicating devices.

The transmitter reference signals, thus allow a receiving communication device, or a plurality of receiving communication devices, to identify the signal(s) as coming from a transmitting communication device in the set of transmission devices.

Based on modulations, information in the coded light can be detected using any suitable light sensor. This can be a dedicated photocell (point detector), an array of photocells possibly with a lens, reflector, phosphorous diffuser etc., or a camera comprising an array of photocells (pixels) and a lens for forming an image on the array. E.g., the light sensor may be a dedicated photocell included in a dongle which plugs into the end point, or the sensor may be a general purpose (visible or infrared light) camera of the end point, or an infrared detector initially designed for instance for 3D face recognition. Either way this may enable an application running on the end point to receive data via the light.

In OWC or other wireless transmission systems, best performance in terms of throughput or power consumption can be achieved if the wireless signal is highly directed to the intended receiver. Radiation can easily be collimated in one direction. The direction of the beam can be controlled by a mechanism or functionality to select or to steer the beam.

Therefore, (optical) wireless systems may have a (sectorized) discrete set of selectable fixed beams or may allow a continuous change of direction of an individual beam.

“Enhancing indoor optical wireless communication system performance by sectorization”, by Jean-Paul Linnartz et al, published in Proceedings of the SPIE, SPIE, US vol. 12022, 4 March 2022, discloses an optical wireless communication system, where a transmitter comprises four segments fitted with free-form optics and its performance and characteristics are discussed, for a Lambertian and a directional detector, further indicating that sectorization and beam selection can improve power efficiency by providing a form of angular diversity.

However, if a wireless signal is received from multiple sectors, the exact relative strength of each sector is hard to estimate. Moreover, detection complexity of codes used for identification may require searches in time and code domains, which requires the many parallel correlators and thus high processing power and power consumption.

### SUMMARY OF THE INVENTION

It is an object of the present invention to provide a sectorized transmission system with reduced processing power and power consumption.

This object is achieved by an apparatus as claimed in claim 1 and 2, by a transmitter as claimed in claim 12, by a receiver as claimed in claim 13, by a transceiver as claimed in claim 14, by a method as claimed in claim 15 and 16, and by a computer program product as claimed in claim 17.

According to a first aspect, an apparatus is provided for controlling a transmitter to emit a target information through at least one of a plurality of emission sectors or beams, the apparatus being configured to:
add a common synchronization code and a sector-specific identification code to respective signals emitted through each of the plurality of emission sectors or beams;
determine from a received feedback signal a sector-specific identification code of at least one selected emission sector or beam to be used for emitting the target information; and
control the transmitter to emit the target information through the selected at least one emission sector or beam;
wherein the common synchronization code and the sector-specific identification codes are emitted as scrambled code sequences that are mutually orthogonal.

According to a second aspect, an apparatus is provided for controlling a receiver to support in selecting at least one of a plurality of emission sectors or beams from a source device (e.g., the transmitter controlled by the apparatus of the first aspect), the apparatus being configured to:

Detect a common synchronization code emitted via each of the plurality of emission sectors or beams in a received signal from the source device;
use the detected common synchronization code to descramble the received signal to derive a sector-specific identification code of one or more of the plurality of emission sectors or beams;
determine a respective reception quality of the derived sector-specific identification code; and
transmit feedback information to the source device based on the determined respective reception quality;
wherein the common synchronization code and the sector-specific identification codes are received as scrambled code sequences that are mutually orthogonal.

According to a third aspect, a method of controlling a transmitter to emit a target information through at least one of a plurality of emission sectors or beams is provided, the method comprising:
adding a common synchronization code and a sector-specific identification code to respective signals emitted through each of the plurality of emission sectors or beams;
determining from a received feedback signal at least one sector-specific identification code of a selected emission sector or beam to be used for emitting the target information; and
controlling the transmitter to emit the target information through the at least one selected emission sector or beam;
wherein the common synchronization code and the sector-specific identification codes are emitted as scrambled code sequences that are mutually orthogonal.

According to a fourth aspect, a method of controlling a receiver to support in selecting at least one of a plurality of emission sectors or beams from a source device, the method comprising:
detecting a common synchronization code emitted via each of the plurality of emission sectors or beams in a received signal from the source device;
using the detected common synchronization code to descramble the received signal to derive sector-specific identification codes of one or more of the plurality of emission sectors or beams;
determining a respective reception quality of the derived sector-specific identification code; and
transmitting feedback information to the source device based on the determined respective reception quality;
wherein the common synchronization code and the sector-specific identification codes are received as scrambled code sequences that are mutually orthogonal.

According to a fifth aspect, a transmitter comprising an apparatus according to the first aspect is provided.

According to a sixth aspect, a receiver comprising an apparatus according to the second aspect is provided.

According to a seventh aspect, a transceiver comprising a transmitter according to the fifth aspect and a receiver according to the sixth of aspect is provided.

According to an eighth aspect, a computer program product is provided, which comprises code means for producing the steps of the above method of the third aspect or the fourth when run on a controller.

Accordingly, transmissions or emissions (beacons) are directed into a plurality of segments or through a plurality of beams, wherein each beacon includes an individual sector identification code together with a synchronization code that is common to all beacons and wherein the synchronization and identification codes are scrambled and mutually orthogonal. The receiving end may then first detect the synchronization symbols (e.g., via autocorrelation) and then retrieve the sector identification by using the synchronization code for descrambling the sector identification code. Thereby, processing power and power consumption at the receiving end can be reduced. The timing of the synchronization code versus the respective identification codes may be fixed and known at the receiver.

According to a first option of any of the first to eighth aspects, the scrambled code sequences of the common synchronization code and the sector-specific identification codes may be scrambled code division multiple access (CDMA) sequences. Thus, CDMA symbols can be combined using channel coding (e.g., Manchester coding) to reduce processing requirements and detection latency at the receiving end.

According to a second option of any of the first to eighth aspects, which can be combined with the first option, the scrambled code sequences of the common synchronization code and the sector-specific identification codes may be scrambled Walsh-Hadamard sequences. Thereby, an attractive solution for the code choice is provided, which allows implementation in a simple microcontroller, identification and estimation of relative strengths of multiple sectors during a sector handover, and data transmission in multi-point systems.

According to a third option of any of the first to eighth aspects, which can be combined with the first or second option, the scrambled code sequence of the common synchronization code may comprise a scrambled sequence of identical binary values. Thus, the synchronization code corresponds to the scrambling code (e.g., a pseudo noise (PN) sequence) and can therefore be directly used for descrambling the sector identification code in a simple manner in a simple manner (e.g., by a multiplication process).

According to a fourth option of any of the first to eighth aspects, which can be combined with any one of the first to third options, the common synchronization code and one of the sector-specific identification codes may be combined for each of the plurality of sectors or beams by using Manchester channel encoding. Thereby, frequent line voltage transitions can be ensured, which are directly proportional to the clock rate. This is helpful for clock recovery. Furthermore, the DC component of the Manchester-encoded signal is not dependent on the data and therefore carries no information. Therefore, connections may be inductively or capacitively coupled, allowing the signal to be conveyed conveniently by galvanically isolated media.

According to a fifth option of any of the first to eighth aspects, which can be combined with any one of the first to fourth options, the sector-specific identification codes may be derived by multiplying the received signal by the detected common synchronization code, performing downsampling of the multiplication result and decoding the downsampled multiplication result. Thereby, a simple reception process can be provided to reduce processing requirements and power consumption at the receiving end.

According to a seventh option of any of the first to eighth aspects, which can be combined with any one of the first to sixth options, an additional sector-specific identification code of the selected at least one emission sector or beam can be added to the respective signals. Thereby, the main transmission sector or beam which is used for transmitting a user stream (i.e., useful data) can be directly derived from the beacons.

According to an eighth option of any of the first to eighth aspects, which can be combined with any one of the first to seventh options, a user stream for communication or power transmission or application control is emitted as useful data through the selected at least one emission sector or beam, wherein the synchronization and identification codes and the useful data are emitted by using different parts of an available modulation spectrum. This provides the advantage that different frequency ranges are used for the beacons and the useful data, which facilitates reception and reduces interference.

According to a ninth option of any of the first to eighth aspects, which can be combined with any one of the first to eighth options, at least some of the derived sector identification codes which are weighted by a value that corresponds to the determined reception quality are fed back from the receiving end, or at least one of the plurality of emission sectors or beams is selected based on the determined reception quality and the derived sector identification code of the selected at least one emission sector or beam is fed back from the receiving end. Thereby, the transmitter is provided with information required to determine the main emission sector or beam to be used for emitting the useful data.

It is noted that the above apparatuses may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1 and 2, the transmitter of claim 12, the receiver of claim 13, the transceiver of claim 14, the method of claim 15 and 16, and the computer program product of claim 17 may have similar and/or identical preferred embodiments, in particular, as defined in the dependent claims.

It shall be understood that a preferred embodiment of the invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the following drawings:

FIG. 1 shows schematically a block diagram of a transmitter with sectorized optical emitters, according to various embodiments;

FIG. 2 shows schematically a block diagram of a transmitter with steerable directional optical emitters, according to various embodiments;

FIG. 3 shows schematically a block diagram of an example of a transmitter with sectorized optical emitters with synchronization and identification codes according to an embodiment;

FIG. 4 shows schematically a block diagram of an example of a microcontroller for generating Manchester-encoded signals;

FIG. 5 shows schematically a flow diagram of a coding and transmission procedure according to an embodiment;

FIG. 6 shows schematically a block diagram of an example of a receiver for code-based selection of beam sectors according to an embodiment; and

FIG. 7 shows schematically a flow diagram of a detection and selection procedure according to an embodiment.

### DETAILED DESCRIPTION OF EMBODIMENTS

Various embodiments of the present invention are now described based on an OWC system where different codes are transmitted in different beams or (beam) sectors.

Throughout the following, a transmitter or emitter may be understood as a directional radiation source that generates visible or non-visible light (i.e., including infrared (IR) or ultraviolet (UV)) light sources) or other radiation for communication or signaling purposes. The transmitter or emitter may be included in a luminaire, such as a recessed or surface-mounted incandescent, fluorescent or other electric-discharge luminaires. The concepts may also be used in peer-to-peer communication between smartphones or Internet of Things (IOT) devices.

It is further noted that when using OWC based on invisible parts of the light spectrum, such as infrared and/or or ultraviolet, the system can be fully decoupled from any illumination systems. In such scenarios the optical wireless communications systems may function to primarily provide communication or signaling, and a separate transceiver node may be used in the optical wireless communication system. Alternatively, such optical wireless communication systems may be complementary to a further function and thus be integrated in other application devices that benefit from such communication functionality; such as personal computers, personal digital assistants, tablet computers, mobile phones, televisions, etc.

The following embodiments are related to an OWC system that comprises at least one transmitter capable of sending data into one or more different, possibly partially overlapping sectors. To identify which segment(s)/sector(s) is (are) most suitable for communication, a set of code signals is added in the sectors around a primary segment/sector (main segment/sector) that is assigned for data communication. Different code signals may be used for every sector.

During a communication session in the sectorized OWC system, one beam or sector may be identified as main beam or main sector for communication (or power delivery) and all adjacent beams or sectors may carry some identifier code to allow detection whether one other sector would be more suited for communication.

More specifically, a transmitting end (e.g., transmitter or transceiver) of the OWC system may emit beacons of a specific nature in different directions, that allow a detection at a receiving end (e.g., receiver or transceiver) as to which emitter(s) or beam sector(s) of the transmitting end can be used to transmit data to the receiving end. The receiving end feeds back this information to the transmitting end, so that the transmitting end can transmit data over an optical channel using the selected emitter(s) or beam sector(s).

During a communication session, at least one sector also emits a user data stream (e.g., a data stream with high bitrate) as useful data, wherein the proposed code signals and useful data may use respective different parts of an available modulation spectrum (e.g., sector IDs may be transmitted by using a carrier frequency below 100 kHz).

In an angle diversity/segmented optical wireless transmitter, sector or beacon identification codes (sectors IDs or beacon IDs) may be emitted in each segment, wherein an optical wireless receiver is configured to decode received sector identification codes and return selected ones to the transmitter to thereby select a specific segment that shall be used for data transmission.

In embodiments, the beacons may be transmitted in a synchronized manner into each segment and each beacon may include its individual sector identification code together with a synchronization code which may be a code orthogonal to the sector identification code and common to all beacons. The receiving end may then first detect the synchronization symbols and then retrieve the sector ID.

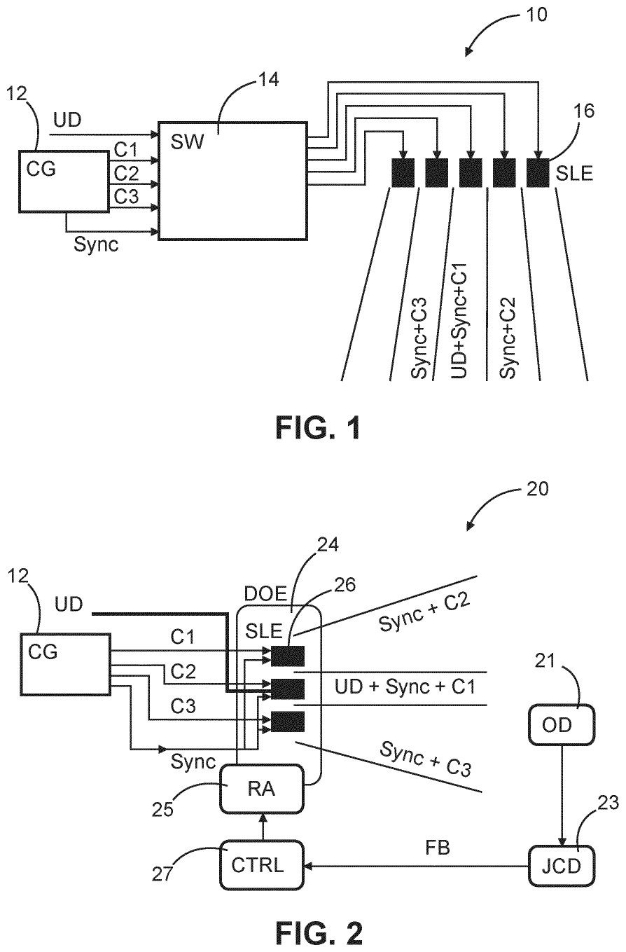

FIG. 1 shows schematically a block diagram of a transmitter 10 with sectorized optical emitters, according to various embodiments.

It is noted that—throughout the present disclosure—only those structural elements and functions are shown, which are useful to understand the embodiments. Other structural elements and functions are omitted for brevity reasons. Furthermore, components, elements, functions or units with same reference numbers have the same or similar functionalities in all embodiments and may not be described again in connection with every embodiment where they appear.

The transmitter 10 of FIG. 1 is used in an OWC system with a (sectorized) discrete set of selectable fixed beams. A code generator (CG) 12, which may be implemented by a programmable signal processor or other processing circuit, is configured to generate a common synchronization code (Sync) and individual sector IDs C1, C2, C3, . . . Cn for every sector of the sectorized transmitter 10.

Furthermore, a routing switch arrangement (SW) 14, which may be implemented by an analog or digital electronic switching circuit, is configured to receive the sectors IDs and synchronization code from the code generator 12, add them to the respective beam signal, and control beam direction of an output signal in order to provide a mechanism or functionality to select or steer the direction of a transmission beam or beam sector. In the embodiment of FIG. 1, this may be achieved by connecting output signals of the routing switch arrangement 14 to a selected one of a plurality of sectorized optical emitters (SLEs) 16.

Additionally, the routing switch arrangement 14 is configured to receive user data (UD) e.g. from a user interface or another input interface and to route the user data to a selected optical emitter 16 of the main sector used for communication.

In an example, the individual sectorized emitters 16 may be placed with some intentional overlap in sector coverage thereby creating diversity, so as to increase the likelihood of the receiver being able to successfully receive an identifier and providing feedback in case one sector is blocked.

The different codes C1 to Cn are simultaneously transmitted in different beams of respective one of the sectorized emitters 16.

Additionally, during a communication session in the sectorized system, one beam (e.g., the beam of the central one of the exemplary five optical emitters 16, as shown in FIG. 1) is identified (e.g., by the routing switch arrangement 14 via a respective feedback signal from the receiving end) as main beam for communication (or power delivery), through which the user data is transmitted together with the sector ID and the synchronization code (e.g., UD+Sync+C1). All or only some adjacent ones of the optical emitters 16 of respective (adjacent) sectors emit respective beams that carry an individual identifier code and the synchronization code (e.g., Sync+C2 or Sync+C3) to enable the receiving end to find out whether one of the other sectors (i.e., optical emitters) would be better suited for communication.

FIG. 2 shows schematically a block diagram of an optical transmitter 20 with steerable directional optical emitters, according to various embodiments.

Such a steerable configuration of the transmitter 20 allows a continuous change of direction of one or more individual beams.

In the example shown on FIG. 2, a continuously steerable beam is generated by a directional optical emitter (DOE), wherein a central part of the beam, which may be generated by a dedicated optical emitter element 26, can be used for main communication (i.e., user data (UD) and synchronization code (Sync) and sector ID (C1)) and neighboring side lobes, which carry respective sector IDs (C2, C3) and the synchronization code (Sync) and which may be generated by dedicated neighboring optical emitter elements 26, can be used for beam tracking.

The optics used in the directional optical emitter 24 of FIG. 2 and/or the array of sectorized optical emitters 16 of FIG. 1 may be configured as a two-dimensional (2D) array with a convex arrangement (e.g., convex mounting plane of the emitters 16 or 26) for spreading the emitted beams. The placement of the emitters 16, 26 on the mounting plane may be a rectangular pattern or a hexagonal pattern with odd or even lines shifted half an emitter relative to one another.

Similar to the optical transmitter 10 of FIG. 1, a code generator (CG) 12 is used for generating the synchronization code and the sector IDs.

A mechanical (e.g., piezo or other electromechanical transducers) or electrical (e.g., phase and or amplitude control) control of the beam direction of the directional optical emitter 24 is performed by a rotational actuator (RA) 25 in response to a respective control signal output by a control circuit (e.g., micro controller) (CTRL) 27. The control signal may be generated based on a feedback information (FB) generated by a joint code detector (JCD) 23 to which a detection output from an optical detector (OD) 21 at the receiving end is supplied.

Thus, a control loop may be stablished to control the rotational actuator 25 until the sector ID of the main beam is received with the highest or at least a sufficient reception quality (e.g., error rate, signal strength, signal-to-noise ratio (SNR) or the like).

The steerable transmission system of FIG. 2 uses a directional field-of-view (FOV) for a primary function of data transmission (or power supply) and has an additional control function to set the direction of the FOV for the primary function based on coded light signals in sectors adjacent to or partially overlapping to the FOV of the primary function.

Each adjacent sector is identified by an individual code (sector ID C1 to Cn) that may provide or may be associated with a steering control signal (e.g., output by the control circuit 27) to direct the primary FOV via the rotational actuator 25.

In an example, the set of codes comprising the sector IDs and the synchronization code may be synchronized and particularly designed (e.g., orthogonal) to allow simultaneous detection of multiple codes at the receiving end, e.g., by the joint code detector 23 based on the output signal of the optical detector 21.

According to embodiments, use can be made of a predominant line of sight characteristic between the optical transmitter and the receiving end, with little influence by (strongly) delayed multipath reflections of codes with excellent cross correlation, so that little emphasis needs to be put on temporal properties with less (or no) constraints on autocorrelation. Furthermore, the transmission of a synchronization code that is common to all sectors is continuously accompanied by a simultaneous sector-unique identification code (sector ID).

Thus, two code symbols (e.g., code division multiple access (CDMA) codes) are suggested to be combined using e.g. a Manchester channel coding, thereby allowing for a very low processing cost and low-latency detection at the receiving end.

More specifically, a sectorized emitter emits in two or more (e.g., dynamically chosen) sectors towards a counter station (receiving end) a sector identification code (e.g., sector ID) and a synchronization code. The combined codes that are emitted in each sector include a direct current (DC) code component (e.g., all bit values of the code set to the same binary value, e.g., “0” or “1”) used for synchronization and a sector-specific identification code. The combination of codes is scrambled (e.g., combined with a pseudo-noise (PN) sequence or another code that is good for synchronization) to convert the DC code component into a synchronization code. The proposed scrambling is also advantageous in that it keeps the set of codes orthogonal and thereby prevents or reduces mutual interference at the receiving end.

As regards selection of suitable code types, the so-called Gold code or Gold sequence is a type of binary sequence used in telecommunication (e.g., CDMA) and satellite navigation (e.g., global positions system (GPS)) and named after Robert Gold. Gold codes have bounded small cross-correlations within a set, which is useful when multiple devices are broadcasting in the same frequency range. A set of Gold code sequences consists of 2n+1 sequences each one with a period of 2n−1.

However, Gold codes are not perfectly orthogonal. This means that if a signal is received from multiple sectors, the exact relative strengths of each sector is hard to estimate. Moreover, detection of Gold codes is complex, as it requires a search in time domain and a search per codes, so that many parallel correlators are required. This increases performance requirements of involved processors and power consumption.

Therefore, a more attractive solution for the code choice is proposed, which allows implementation in a simple microcontroller, identification and estimation of relative strengths of multiple sectors during a sector handover, and data transmission in multi-point systems.

The so-called Hadamard code is a code named after Jacques Hadamard that is used for error detection and correction when transmitting messages over very noisy or unreliable channels. The Hadamard code is also known under the names Walsh code, Walsh family, and Walsh-Hadamard (WH) code in recognition of the American mathematician Joseph Leonard Walsh. In CDMA communication, the WH code can be used to define individual communication channels. It is usual in the CDMA literature to refer to codewords as “codes”. Each user will use a different codeword, or “code”, to modulate their signal. Because WH codewords are mathematically orthogonal, a WH-encoded signal appears as random noise to a CDMA-capable receiver, unless that receiver uses the same codeword as the one used to encode the incoming signal.

Other relevant properties of the WH code that contribute to the disclosed embodiments are that firstly one of the available code patterns is an all-one code (i.e., just a constant-valued (i.e., DC) signal) and secondly that a specific CDMA-capable receiver can simultaneously decode all possible encoded signals in a computational efficient manner. More specifically, the fast WH transform is a butterfly operation on an input sequence of incoming received time samples that generates the whole modulated signal simultaneously at its output. If the WH code length is L, the butterfly operates over L samples, in log L stages, where the logarithm is base 2. A butterfly decoder for a WH code matrix requires only additions and subtractions so that it has a very high computational efficiency and is thereby very suitable for parallel estimation of individual signal strengths of signals received via multiple sectors or beams.

In the following embodiments, a WH code of length 16 is used for the sector ID code to accommodate a maximum number of 15 beams, while the remaining code portion is used to carry a synchronization code. In particular, the all-one code is a suitable option for the synchronization code, because the transmitted scrambled synchronization signal then become equal to the scrambling code itself.

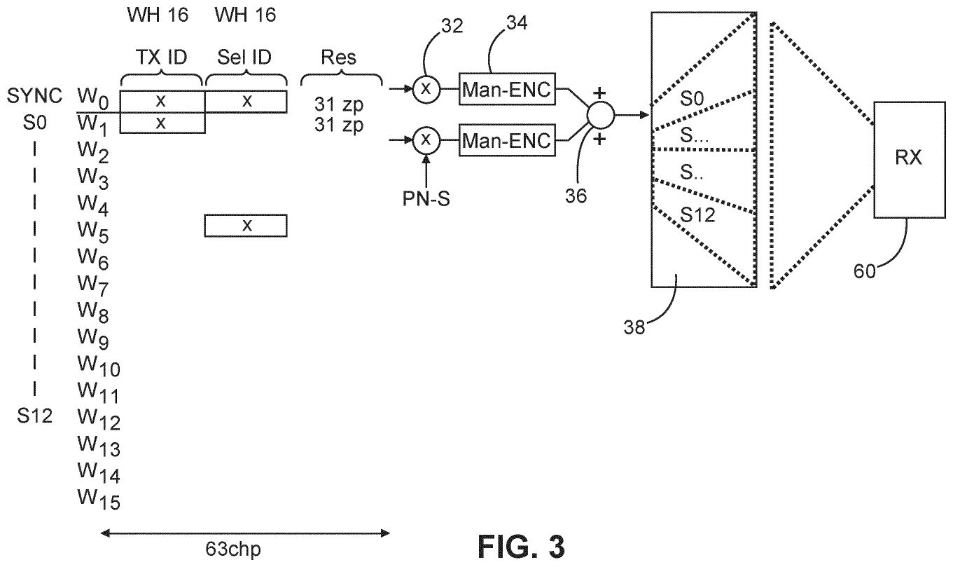

FIG. 3 shows schematically a block diagram of an example of a transmitter functionality with an emitter arrangement 38 comprising sectorized optical emitters, wherein a WH synchronization code (SYNC) and WH identification codes (sector IDs) are used for thirteen sectors SO to S12, according to an embodiment.

The emitter arrangement 38 may comprise a plurality of directional emitters for directionally transmitting in the different sectors SO to S12 with different directions or each generating at least one beam that covers one of the different sectors SO to S12. Each of the emitters may be laid out in a 2D array form or a hexagonal or other-shaped pattern.

Optionally, the sectors SO to S12 may overlap from a certain distance of the emitter arrangement 38 onwards.

In digital communications, a chip is a pulse of a direct-sequence spread spectrum (DSSS) code used in direct-sequence CDMA channel access techniques. In such a binary direct-sequence system, each chip may be a rectangular pulse of a binary amplitude (0/1 or +1/−1 code values), which may be multiplied by a data sequence (similarly code values representing the message bits) and by a carrier waveform to obtain the transmitted signal. The chips may therefore be just a bit sequence output by the code generator 12. They are called chips to avoid confusing them with message bits.

DSSS is a spread-spectrum modulation technique primarily used to reduce overall signal interference. The direct-sequence modulation makes the transmitted signal wider in bandwidth than the information bandwidth. After de-spreading or removal of the direct-sequence modulation in the receiver, the information bandwidth is restored, while the unintentional and intentional interference is substantially reduced. Some practical and effective uses of DSSS include CDMA, WiFi (e.g., IEEE 802.11b specification), and GPS.

The left portion of FIG. 3 shows an exemplary list of 63-chip codes W0 to W15 each consisting of two 16-chip WH code portions (WH16) and one 31-chip reserved portion (Res) consisting of 31 chips which are zero padded (zp). The first WH code portion can be used for signaling a transmission (TX) beam ID (TX ID, i.e., the sector ID) and the second WH code portion can be used for signaling the beam ID (Sel ID) of the selected main beam (main sector) that is used for transmitting the user data.

These codes may be stored in a memory (e.g., look-up table) of the code generator 12 of FIGS. 1 and 2 and can be selected for signaling the synchronization code and the sector ID codes via the emitted beams or beam sectors.

In the example of FIG. 3, the specific most upper code WO of the code list is selected as the synchronization code (e.g., all chips set to the same binary code value) which is common for all sectors.

Furthermore, as shown in FIG. 3, besides the synchronization code, sector SO is sequentially modulated with its corresponding identification code (i.e., code W1) as TX beam ID and sector S4 (i.e., code W5) is used for signaling the beam ID (Sel ID) of the selected main beam as part of the feedback data. After zero padding of the chips of the reserved portion, the two resulting streams of length 63 chips for the synchronization code and the sector identification code are each multiplied (e.g., XORed) in the time domain by a PN sequence in respective analog or digital multiplier circuits 32 to obtain scrambled code sequences.

In an example, the PN sequence may correspond to the output of a maximum length linear feedback shift register (ML LFSR) sequence. Such codes have the advantageous property that their autocorrelation has one large peak for zero time offset (this can be interpreted as the power of the sequence) and has a very low autocorrelation for any non-zero time offset. Ideally, the autocorrelation would be zero (if the signal is interpreted as {−1,1} values). Two PN sequences with an odd length cannot have an exactly zero correlation, but for ML LFSR, the autocorrelation is very close to zero compared to the autocorrelation at zero offset. Such properties make the code very suitable for synchronization.

In the embodiment of FIG. 3, the synchronization code and the identification codes form a WH code set, but each signal is multiplied (XORed) in time domain by a common PN sequence. In an example, the chip time of the PN sequence and the WH code may be identical and the code duration of the PN sequence (2N−1) and WH sequence (2M) may be matched, wherein integer N is larger or equal than integer M and where some “tweaking” of either code is performed to repair the “minus 1” of the length of the PN sequence. This may be achieved by adding one zero to the PN sequence to obtain an even-numbered length 2, or the common “all 1” instant of the WH code can be omitted to obtain an odd-numbered length 2M−1. When choosing N>M, the additional WH sequences could be used to implement the aforementioned feedback data or to increase the address space of the sector identification codes. The length of the PN sequence is larger than that of the WH codes by a factor of 2N−M (i.e., 2, 4, 8, . . . ) . This allows embedding of extra data or an increase of the address space. This may also be accomplished by selecting a larger M.

Furthermore, the processed synchronization code and sector identification codes may be supplied to respective subsequent Manchester encoders (Man-ENC) 34 used to obtain a DC-free modulation sequence. Manchester coding is a special case of binary phase-shift keying (BPSK), where the data controls the phase of a square wave carrier whose frequency is the data rate (chip rate). Manchester code ensures frequent light level transitions, directly proportional to the clock rate, which is helpful for clock recovery and for signal level estimation. Furthermore, the DC component of the encoded signal is not dependent on the data and therefore carries no information. Therefore, connections may be inductively or capacitively coupled, allowing the signal to be conveyed conveniently by galvanically isolated media. This is advantageous for modulating subsequent sectional optical emitters of an emitter arrangement 38 for the sections S0 to S12 but also for detecting the coded optical signals at the receiving end. For instance, this is advantageous to remove a (constant) background light intensity of DC biases in the electronics, such as at the input of amplifiers.

In a combination unit 36 (e.g., analog or digital adder circuit), the two scrambled code sequences may then be combined (e.g., added, possibly with some weighting factors) before being supplied to the optical emitters of the emitter arrangement 38. A weighting factor could for example be applied when the received synchronization code becomes much stronger with respect to identification codes due to sector overlapping. A way to restore that balance is to add the synchronization code with a weighting factor<1.

The proposed OWC system can be used in a bidirectional way. Each node with optical transmitter may not only transmit an optical signal with different sector identification code (sector ID) in each sector but may also contains a receiver (not shown in FIG. 3). That is, the optical transmitter may be an optical transceiver or may comprise an electrical receiver for receiving a response or feedback signal from the receiving side via a wired or wireless channel. After decoding an incoming feedback signal from an optical receiver (RX) 60 at the receiving end, the transmitter may derive an identification code of a beam sector with the best reception quality and may then use the indicated best suited (e.g., strongest) beam sector for transmitting the optical signal towards the receiving end as part of the feedback solution.

In an example, the feedback data from the receiving end (i.e., receiver 60) may also use CDMA codes and may feedback more than one or even all sector IDs weighted by a value that corresponds to the received signal strength or other quality parameter, per received sector.

In an example, the synchronization code and the identification codes (sector IDs) may jointly form a new set of codes which are orthogonal to each other.

Optionally, at least the synchronization code may be configured to provide good autocorrelation properties, which may involve at least one of the requirements of being symmetrical, being an even function, being a Hermitian function and being periodical.

In the present example, desirable property of the synchronization code is that the autocorrelation output is a high value for zero offsets only and is (near) zero for non-zero offsets. A receiver can then search for a synchronization by correlating with a locally stored copy of the sequence and if there is a time offset between the transmitter and receiver clocks, the correlation between the incoming received sequence and the locally generated copy should be at least close to zero.

If the selected main beam is used for transmitting user data or a power signal, a data/power signal is added to the optical signal conveyed through the main beam. Thus, each sector emits the common synchronization code plus the individual sector identification code and at least one sector (main beam) also emits the data/power signal. The (modulation and/or optical) spectrum of the data/power signal may be disjoint from that of the synchronization code and the sector identification code. In an example, the synchronization and sector identification code may use a lower part of the modulation spectrum where multipath delays, if any, do not lead to significant time shifts that would challenge the autocorrelation.

In an example, the optical transmitter of the OWC system of FIG. 3 may be configured to provide a rotatable emitter arrangement 38 which can be controlled based on the feedback information from the receiver 60 such that a particular central sector points towards the receiver 60.

In a further example, the feedback control can be based on a relative strength estimation of multiple overlapping sectors to calculate the position of the receiver 60 relative to the emitter arrangement 38.

In another example, code-carrying control guidance beams (e.g., sidelobe sectors) can be configured by the emitter arrangement 38 to overlap to such an extent that a control signal (e.g., the synchronization code and the sector identification code) can be received in all tracking positions of the rotatable emitter arrangement 38.

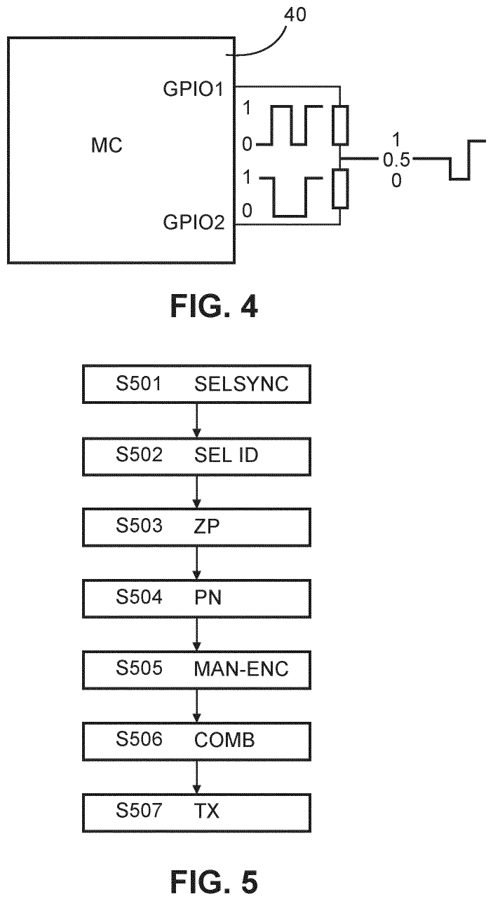

FIG. 4 shows schematically a block diagram of an example of a microcontroller (MC) 40 that may be used to implement the Manchester encoders 34 for generating the Manchester-encoded signals of the synchronization code and the sector identification code.

As explained above, the two signals after Manchester-encoding are bi-level signal (with levels “0”and “1” or “−1” and “+1”, etc.). This means that they can easily be generated by using two general purpose input/output (GPIO) (push-pull) ports GPIO1 and GPIO2 of the microcontroller. A push-pull GPIO port is configured to both source and sink current. With a push-pull GPIO, a transistor or other switch element may connect to high potential (e.g., supply voltage) or reference potential (e.g., ground) to drive a signal to high (“1”) or low (“0” or “−1”) binary state. When the output goes the low binary state, the output port is actively “pulled” to reference potential (e.g., ground), and when the output goes to the high binary state, the output port is actively “pushed” to the supply voltage.

Throughout the present disclosure, values of binary code signals may be chosen from the {0,1} alphabet or {−1,1} alphabet. The former is a more common approach for Manchester codes and for PN linear feedback register codes, while the latter is more likely to be used for WH codes to simplify the mathematical operations. The scrambling operation may for instance be a multiplication if signals are in the {−1,1} range, or an (inverted) XOR operation (addition modulo 2) if signals are in the {0,1} range. In connection with the emission process, binary levels are typically emitted as two different light intensities, where one of these levels may be zero (as in on-off keying).

The summation of the signals in the combination unit 36 may then be done as a linear operation, e.g., by using two resistors as shown in FIG. 4.

As indicated above, one of these GPIO ports outputs the synchronization code pattern common for all sectors SO to S12. As will be clear to those skilled in the art, the use of GPIO pins here is used to elucidate the concept, however, a dedicated set of synchronized parallel-to-serial converters, optionally with a buffer, may be used instead to drive the Manchester signal, thereby substantially relaxing timing requirements, but adding latency.

It is noted that the WH codes (e.g., WO to W15 of FIG. 3) have excellent cross correlation properties. However, within the set of WH codes one code (e.g., WO of FIG. 3) contains zeros only and is thus a DC code, while the remaining other codes are DC-free. However, this property changes after the WH codes have been multiplied (XORed) in the time domain by the common PN sequence. The resulting new set of codes contain DC levels which now differ per code, wherein the amount of DC may depend on the emitted sector identification code (TX ID in FIG. 3) and feedback data (Sel ID in FIG. 3).

Proper detection of the relative strength of all sector signals at the receiver 60 requires that all codes (e.g., synchronization code and sector identification code) including their DC contribution are present at the receiving end. If this is not the case, omission of DC contribution may lead to a loss of orthogonally, additive DC components due to e.g. biasing circuitry or environmental DC light may lead to a spurious PN sequence component after PN sequence removal at the receiver 60.

Note that the DC properties discussed above are related to the codes and are measured over the full code length. The fact that the emitted codes may contain components with relatively low frequency (as there are no provisions on limiting the maximum repetition of identical chips) complicates DC blocking function in the transmitter-receiver chain.

The proposed Manchester encoding function after multiplication with the PN code solves the above problem by allowing AC-coupling (CD blocking) of emitter and receiver signals while the orthogonal property of the received code signals is maintained. Thus, the transmission chain is not sensitive to additive DC and low frequency components can be limited to 1/(4*Manchester encoded chips times). As a result, a DC blocking function can be implemented in a relatively easy way.

FIG. 5 shows schematically a flow diagram of a coding and transmission procedure according to an embodiment.

In a first step S501 (SEL SYNC), a synchronization code (e.g., a specific WH code such as WO) is selected as a common code used for all emission beams or sectors.

Then, in step S502 (SEL ID), respective beam/sector identification codes (e.g., specific WH codes) are allocated to the beams/sectors used for transmission.

In step S503 (ZP), any remaining chips of the selected and allocated codes are zero padded.

In subsequent step S504 (PN), the obtained synchronization code and respective sector identification code for each emitted beam/sector are each multiplied by a PN sequence and are then Manchester-encoded in step S505 (MAN-ENC).

Then, in step S506 (COMB), the parallel streams of Manchester-encoded code signals are combined (e.g., added) to form a single stream for each beam/sector.

Finally, an optical transmission signal (carrier) of each beam/sector is modulated with the respective single stream including the synchronization code and the sector identification code.

Optionally, if the procedure is used for transmitting user data or a power signal or other application data, this data is added to the stream of a selected main beam/sector selected based on information about the reception quality which may have been fed back from the receiving end.

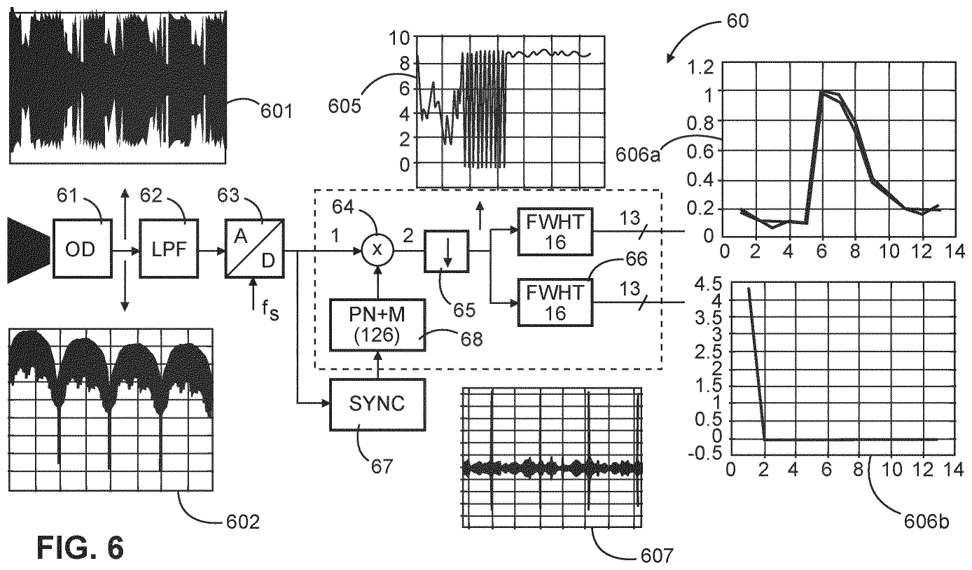

FIG. 6 shows schematically a block diagram of an example of a functionality of a receiver 60 (e.g., the receiver 60 of FIG. 3) for code-based selection of beam sectors according to an embodiment.

In a first part of the receiver, an optical signal received through one or more of a plurality of beams/sectors is detected by an optical detector (OD) 61, which may comprise a single optoelectrical transducer (e.g., optical sensor element) or an array of optoelectrical transduces. An example of the received signal is shown in diagram 601 in the time domain (i.e., signal waveform) and in diagram 602 in the frequency domain (i.e., signal spectrum).

Then, the received and converted signal is supplied to a low pass filter (LPF) 62 to reject noise and interference and is then converted by an analog-to-digital converter (ADC) 63 from the analog domain to the digital domain by using a sampling frequency fs.

The decoder functionality of the receiver 60 starts after the ADC 63. The pattern of the synchronization code (SYNC) of the received and A/D-converted signal may be detected by detector 67 which may comprise an auto-correlator to detect the synchronization pattern which is common to all beams/sectors based on a branched-off component of the received digital signal. Diagram 607 shows correlation output values vs. shifting values at the output of the correlator of the detector 67, which uses a synchronization chip correlation procedure covering 126 chips. Based on the timing recovery obtained from the detector 67, extractor 68 generates the pattern of the detected synchronization code with combined PN and Manchester encoding time synchronous to the incoming signal with a length of 126 chips.

Thus, receiver 60 can be synchronized by means of a correlation with the detected pattern of the received common synchronization code at the output of the extractor 68 and provides an operation to decode the sector identification codes (sector IDs).

As initial steps of the decoder function, the PN sequence multiplication of the received digital signal must be removed in the main branch of the decoder part of the receiver 60 (descrambling). This may be accomplished by a combination of multiplication of the received digital sequence 1 with the extracted synchronization code by a multiplier 64 and subsequent downsampling by a downsampler 65. Downsampling may be achieved by a process of resampling or bandwidth reduction (filtering) or sample-rate reduction. When the downsampling process is performed on a sequence of samples of the received digital signal 2 at the output of the multiplier 64, it produces an approximation of the sequence that would have been obtained by sampling the signal at a lower rate. Diagram 605 shows a waveform of an example of the descrambled and downsampled signal at the output of the downscrambler 65.

Then, the descrambled and downsampled signal is branched into two parallel sequences supplied to respective WH decoder units 66, where the decoding of the sector identification codes can be performed for all sector identification codes in one common processing, e.g., by executing a WH matrix operation (WH transform) of a set of incoming code samples, after the PN sequence has been removed from samples.

The WH transform is an example of a generalized class of Fourier transforms. It performs an orthogonal, symmetric, involutive, linear operation on 2^{M} real numbers (or complex, or hypercomplex numbers, although the WH matrices themselves are purely real). The WH transform can be regarded as being built out of size-2 discrete Fourier transforms (DFTs), and is in fact equivalent to a multidimensional DFT of size 2×2× . . . ×2×2. It decomposes an arbitrary input vector into a superposition of WH functions.

After downsampling, the first 16 chips of the obtained sequence are used to determine the relative strengths of all sectors from which a signal has been received. This may be achieved by determining the amplitudes as the output vector of one fast WH transform which is an efficient algorithm to compute the WH transform. Thereby, all sector identification codes can be simultaneously decoded in one go.

Moreover, individual strengths of all sector identification codes can be determined by a (memory-efficient) in-place operation that calculates a single fast WH operation in parallel. This makes it computational highly efficient and highly scalable for many sectors. In computer science, an in-place algorithm is an algorithm which transforms input using no auxiliary data structure. The input is usually overwritten by the output as the algorithm is executed. An in-place algorithm updates its input sequence only through replacement or swapping of elements.

The next 16 chips are used e.g. in the parallel branch to detect the feedback data. Again, this can be achieved by looking to the amplitudes of fast WH transform.

Thereby, the receiver 60 determines the relative strength of all sector signals, e.g., by looking for the amplitudes at the output of the received WH matrix.

Diagram 606a shows detected and noise-free values of sector signal strengths (received from the counterpart emitter) versus sector ID numbers. Thus, in the present example, sector IDs 6 and 7 provide the highest signal strengths and can be selected for transmitting a desired data, power or other application signal. A decision based on this result can be sent back to that counterpart emitter (not shown in FIG. 6).

The selected the sector ID(s) may then by signaled from the receiver 60 to the transmitter via feedback data to use this (these) sector(s) for transmitting the desired signal.

Diagram 606b shows a characteristic indicating another sector decision versus the sector IDs. The mark “x” at sector ID 1 indicates that this sector ID has been transmitted to the transmitter.

It is noted that any of the described transmitter functionalities (e.g., as shown in FIGS. 1 to 3) may be combined with any of the described receiver functionalities (e.g., as shown in FIG. 6) to obtain a transceiver that incorporates both transmitter and receiver functionalities in a single device.

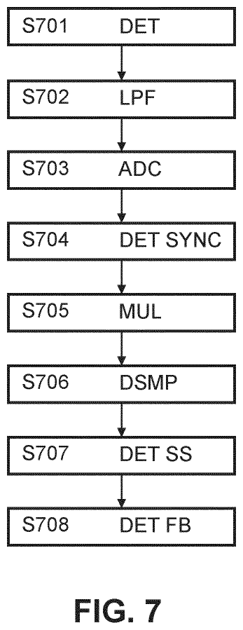

FIG. 7 shows schematically a flow diagram of a detection and selection procedure according to an embodiment.

An optical signal received via a plurality of beams/sectors is detected (step S701), low-pass filtered (step S702) and then AD-converted (step S703) to obtain a digital signal comprising a sequence of signals samples. In step S704, the received sequence is autocorrelated to recover the original timing and extract a pattern of a synchronization code included in all beam/sector signals.

The extracted synchronization pattern is then multiplied in step S705 with the received sequence and subsequently downsampled in step S705 to descramble (e.g., remove an added PN sequence) the received sequence.

Then, in step S707, signal strengths of respective sector identification codes (sector IDs) are determined by performing WH decoding of a related set of chips of the received sequence (e.g., using a fast WH transform) for each received sector identification code.

In step S708, feedback data may be determined by performing WH decoding of another related set of chips of the received sequence (e.g., using a fast WH transform).

To summarize, a wireless communication system with a transmitter that is capable of sending data into one or more different, possibly partially overlapping sectors has been described. To identify which sector(s) is (are) most suitable for communication, a suitable choice of codes is suggested and a set of different code patterns to be used for identifying different sectors are added.

While the invention has been illustrated and described in detail in the drawings and foregoing description, such illustration and description are to be considered illustrative or exemplary and not restrictive. The invention is not limited to the disclosed embodiments. The proposed code-based sector selection concept can be applied to other types of optical or non-optical wireless networks and with other types of access devices, modems and transceivers. In particular, the invention is not limited to LiFi-related environments, such as the ITU-T G.9961, ITU-T G.9960, and ITU-T G.9991 network environment. It can be used in visible light communication (VLC) systems, IR data transmission systems, G.vlc systems, OFDM-based systems, connected lighting systems, OWC systems, and smart lighting systems. Moreover, the proposed types of transmitter, receiver or transceiver could be a used for indoor or outdoor applications. In case of outdoor applications, they could be vehicle mounted 3D system, allowing vehicle-to-vehicle (V 2V) or vehicle-to-infrastructure (V 2I) communication.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated.

The described procedures like those indicated in FIGS. 5 and 7 can be implemented as program code means of a computer program and/or as dedicated hardware of the receiver devices or transceiver devices, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus for controlling a transmitter to emit a target information (UD) through at least one of a plurality of emission sectors or beams, the apparatus configured to:
receive a feedback signal (FB) and determine an identification based thereon;
control the transmitter to emit the target information (UD) through at least one selected emission sector or beam of the plurality of emission sectors or beams;
add a common synchronization code (SYNC) and a sector-specific identification code (TX ID) to respective signals emitted through each of the plurality of emission sectors or beams; and wherein
the determined identification is a sector-specific identification code of the at least one selected emission sector or beam to be used for emitting the target information (UD); and
the common synchronization code (SYNC) and the sector-specific identification codes (TX ID) are emitted as scrambled code sequences that are mutually orthogonal.

2. An apparatus for controlling a receiver to support in selecting at least one of a plurality of emission sectors or beams from a source device, the apparatus configured to:
transmit feedback information to the source device based on a determined respective reception quality;
detect a common synchronization code (SYNC) emitted via each of the plurality of emission sectors or beams in a received signal from the source device;
use the detected common synchronization code (SYNC) to descramble the received signal to derive a sector-specific identification code (TX ID) of one or more of the plurality of emission sectors or beams;
determine a respective reception quality of the derived sector-specific identification codes (TX ID); and wherein
the feedback information is based on the determined respective reception quality of the derived sector-specific identification codes (TX ID);
wherein the common synchronization code (SYNC) and the sector-specific identification codes (TX ID) are received as scrambled code sequences that are mutually orthogonal.

3. The apparatus of claim 1, wherein the scrambled code sequences of the common synchronization code (SYNC) and the sector-specific identification codes (TX ID) are scrambled code division multiple access sequences.

4. The apparatus of claim 1, wherein the scrambled code sequences of the common synchronization code (SYNC) and the sector-specific identification codes (TX ID) are scrambled Walsh-Hadamard sequences.

5. The apparatus of claim 1, wherein the scrambled code sequence of the common synchronization code (SYNC) comprises a scrambled sequence of identical binary values.

6. The apparatus of claim 1, wherein the apparatus is configured to combine the common synchronization code (SYNC) and one of the sector-specific identification codes (TX ID) for each of the plurality of sectors or beams by using Manchester channel encoding.

7. The apparatus of claim 2, wherein the apparatus is configured to derive the sector-specific identification codes (TX ID) by multiplying the received signal by the detected common synchronization code (SYNC), performing downsampling of the multiplication result and decoding the downsampled multiplication result.

8. The apparatus of claim 1, wherein the apparatus is configured to further add a sector-specific identification code (Sel ID) of the selected at least one emission sector or beam to the respective signals.

9. The apparatus of claim 1, wherein the apparatus is configured to emit a user stream for communication or power transmission or application control as target information (UD) through the selected at least one emission sector or beam, and to emit the synchronization and identification codes (SYNC, TX ID) and the target information (UD) by using different parts of an available modulation spectrum.

10. The apparatus of claim 2, wherein the apparatus is configured to feed back at least some of the derived sector identification codes (TX ID) weighted by a value that corresponds to the determined reception quality, or to select at least one of the plurality of emission sectors or beams based on the determined reception quality and feedback the derived sector identification code (Sel ID) of the selected at least one emission sector or beam.

11. The apparatus of claim 1, wherein at least one of a chip time and a code length of the synchronization and identification codes (SYNC, TX ID) and a scrambling code are matched.

12. A transmitter comprising an apparatus according to claim 1.

13. A receiver comprising an apparatus according to claim 2.

14. A transceiver comprising a transmitter of claim 12.

15. A method of controlling a transmitter to emit a target information (UD) through at least one of a plurality of emission sectors or beams, the method comprising:
receiving a feedback signal (FB) and determining an identification based thereon;
controlling the transmitter to emit the target information (UD) through at least one selected emission sector or beam of the plurality of emission sectors or beams;
adding a common synchronization code (SYNC) and a sector-specific identification code (TX ID) to respective signals emitted through each of the plurality of emission sectors or beams and wherein;
the determined identification is a sector-specific identification code (Sel ID) of the at least one selected emission sector or beam to be used for emitting the target information (UD); and
the common synchronization code (SYNC) and the sector-specific identification codes (TX ID) are emitted as scrambled code sequences that are mutually orthogonal.

16. A method of controlling a receiver to support in selecting at least one of a plurality of emission sectors or beams from a source device, the method comprising:
transmitting feedback information to the source device based on a determined respective reception quality;
detecting a common synchronization code (SYNC) emitted via each of the plurality of emission sectors or beams in a received signal from the source device;
using the detected common synchronization code (SYNC) to descramble the received signal to derive a sector-specific identification code (TX ID) of one or more of the plurality of emission sectors or beams;
determining a respective reception quality of the derived sector-specific identification code (TX ID); and wherein
the feedback information is based on the determined respective reception quality of the derived sector-specific identification code (TX ID);
wherein the common synchronization code (SYNC) and the sector-specific identification codes (TX ID) are received as scrambled code sequences that are mutually orthogonal.

17. A non-transitory computer readable medium comprising instructions, the instructions when executed by a processor cause the processor to perform the method of claim 15.
